(19) United States
(12) Patent Application Publication
(10) Pub. No.: US 2020/0217929 A1
(43) Pub. Date: Jul. 9, 2020

(54) DETECTING MISALIGNMENT

(71) Applicants: ZF AUTOMOTIVE UK LIMITED, Solihull West Midlands (GB); ZF Friedrichshafen AG, Friedrichshafen (DE)

(72) Inventors: Martin Hahn, Ebenweiler (DE); Felix Erfurth, Friedrichshafen (DE); Peter Frere, Birmingham, West Midlands (GB); Martin Rändler, Immenstaad (DE); Martin Thompson, Solihull, West Midlands (GB)

(21) Appl. No.: 16/647,604

(22) PCT Filed: Sep. 18, 2018
(86) PCT No.: PCT/GB2018/052649

§ 371 Date: Mar. 16, 2020

(30) Foreign Application Priority Data
Sep. 18, 2017 (GB) 1714978.2

(51) Int. Cl. G01S 7/40; G01S 13/86

(52) U.S. Cl. CPC G01S 7/40; G01S 13/86

(57) ABSTRACT

Apparatus for detecting misalignment of a radar unit (2) of a vehicle (3), the apparatus comprising: a rotational speed sensor (1) arranged to measure the rotational speed of the radar unit (2) about at least one axis and having an output for a signal indicative of the rotational speed; and a processor (5) arranged coupled to the output of the rotational speed sensor; in which the processor (5) is arranged to determine the misalignment at least in part based on the rotational speed measured by the rotational speed sensor (1).

This invention relates to apparatus and methods for detecting misalignment of a radar unit of a vehicle.

It is known to provide radar units in vehicles, particularly as part of systems such as adaptive cruise control and the like. Such systems have to be accurately aligned in the vehicle (as discussed, for example, in the PCT patent application published as WO2016/071696).

However, such systems can become misaligned following, for example, a minor crash event, especially when the “crash” occurs when the driver is not present, such as may happen when the parked vehicle is bumped into by another vehicle (e.g. in a car park or on-street parking situation). In such cases, using the current software-based processes for identifying radar unit misalignment may mean that the vehicle is driven for some considerable distance before the radar is able to recalibrate itself, or the driver is warned that the system is faulty.

As such, it is desirable to be able to establish, within a few seconds of driving off from stand-still, when radar realignment recalibration or driver warning is necessary.

We are aware of U.S. Pat. No. 9,366,751, which discloses a radar unit having an integral 3-axis accelerometer measuring longitudinal, lateral, and vertical linear accelerations. The acceleration measurements from the three-axis accelerometer mounted in the radar unit are compared with those measured by a separate three-axis accelerometer typically mounted at (or close to) the vehicle's centre of gravity. In ideal alignment conditions and with ideal accelerometer calibration, the accelerations measured by both accelerometers should match. In the presence of misalignment of the radar unit, one or more of the acceleration signals will not match between the two accelerometers.

When the degree of misalignment is not too great, an appropriate amount of alignment compensation can then be applied to the processed radar signals. For cases where the detected misalignment is greater than a threshold the radar unit is disabled and a warning message is sent to the driver.

However, this system relies on the vehicle being in motion to work. One reason for this is that azimuthal (yaw) angular misalignment cannot be detected by a static 3-axis accelerometer (because the only acceleration acting on the accelerometer in the static case is that due to gravity, and the component of this acting on a laterally-aligned accelerometer axis is not changed by a purely azimuthal rotation). Hence, this type of misalignment requires the vehicle to be moving if a 3-axis accelerometer is used as the detection means.

According to a first aspect of the invention, there is provided apparatus for detecting misalignment of a radar unit of a vehicle, the apparatus comprising:
a rotational speed sensor arranged to measure the rotational speed of the radar unit about at least one axis and having an output for a signal indicative of the rotational speed
a processor arranged coupled to the output of the rotational speed sensor;
   in which the processor is arranged to determine the misalignment at least in part based on the rotational speed measured by the rotational speed sensor.

As such, by determining the rotational speed about the axis, the apparatus can determine the misalignment about that axis. This is useful where, as discussed above with respect to stationary vehicles, the misalignment about that axis is difficult to determine. The axis may be generally vertical.

The apparatus may comprise an accelerometer arranged to determine the acceleration of the radar unit along at least two axes, and having an output for a signal indicative of the acceleration, with the processor being arranged to use the acceleration to determine the misalignment. Typically, the two axes would be perpendicular to each other and to the at least one axis of the rotational speed sensor. In a preferred embodiment, the rotational speed sensor will be arranged to measure the rotational speed about one axis, and the accelerometer will be arranged to determine the acceleration along at least two perpendicular axes perpendicular to the axis, and optionally also along the axis.

Such a system would be able to determine whether the radar unit was misaligned about three axes, particularly given either a predetermined calibration for the acceleration about the two axes or a further accelerometer coupled to the vehicle and able to determine the acceleration of the vehicle about two or three axes.

Typically, the processor will be arranged to determine the misalignment based upon the output of the rotational speed sensor by integrating the rotational speed. As such, the apparatus may be arranged such as to take measurements of the rotational speed regularly or continually over a period of time. Typically, the period of time will be a period of time over which it is desired to know whether there has been a misalignment. For example, the period of time may comprise at least the period when an ignition of the vehicle is switched off, or a period when the vehicle is stationary.

Alternatively, the rotational speed sensor may be arranged to only measure the rotational speed if it exceeds a threshold. This may be combined with the integration above; as such, the apparatus may be arranged to take measurements of the rotational speed over the period only if the rotational speed exceeds a threshold.

The rotational speed sensor may comprise a gyroscope.

In accordance with a second aspect of the invention, there is provided a vehicle having a radar unit and the apparatus of the first aspect of the invention attached thereto, in which the rotational speed sensor is attached to or integrated in the radar unit.

The vehicle may be provided with a further accelerometer coupled to the vehicle and able to determine the acceleration of the vehicle about two or three axes, with an output of the further accelerometer being coupled to the processor and the processor arranged to determine the misalignment based upon the acceleration of the vehicle.

According to a third aspect of the invention, there is provided a method of detecting misalignment of a radar unit of a vehicle, the method comprising measuring the rotational speed of the radar unit about at least one axis and having an output for a signal indicative of the rotational speed and determining the misalignment at least in part based on the measured rotational speed.

As such, by integrating the rotational speed about the axis, the apparatus can determine the misalignment about that axis. This is useful where, as discussed above with respect to stationary vehicles, the misalignment about that axis is difficult to determine.

The method may also comprise determining, typically using an accelerometer, the acceleration of the radar unit along at least two axes and using the acceleration to determine the misalignment. Typically, the two axes would be perpendicular to each other and to the at least one axis about which the rotational speed is measured. In a preferred embodiment, the rotational speed is measured about one axis, and the accelerometer determines the acceleration along at least two perpendicular axes perpendicular to the axis, and optionally also along the axis.

Such a system would be able to determine whether the radar unit was misaligned about three axes, particularly given either a predetermined calibration for the acceleration about the two axes or a further accelerometer coupled to the vehicle and able to determine the acceleration of the vehicle about two or three axes. The axis may be generally vertical.

Typically, the method will comprise determining the misalignment by integrating the rotational speed. As such, the method may comprise taking measurements of the rotational speed regularly or continually over a period of time. Typically, the period of time will be a period of time over which it is desired to know whether there has been a misalignment. For example, the period of time may comprise at least the period when an ignition of the vehicle is switched off, or a period when the vehicle is stationary.

The measurements of rotational speed may be processed to determine the misalignment as the measurements are made. Alternatively, the measurements may be cached and processed in a batch. The batch may be processed at the end of the period.

There now follows description of an embodiment of the invention, described with reference to the accompanying drawings, in which:

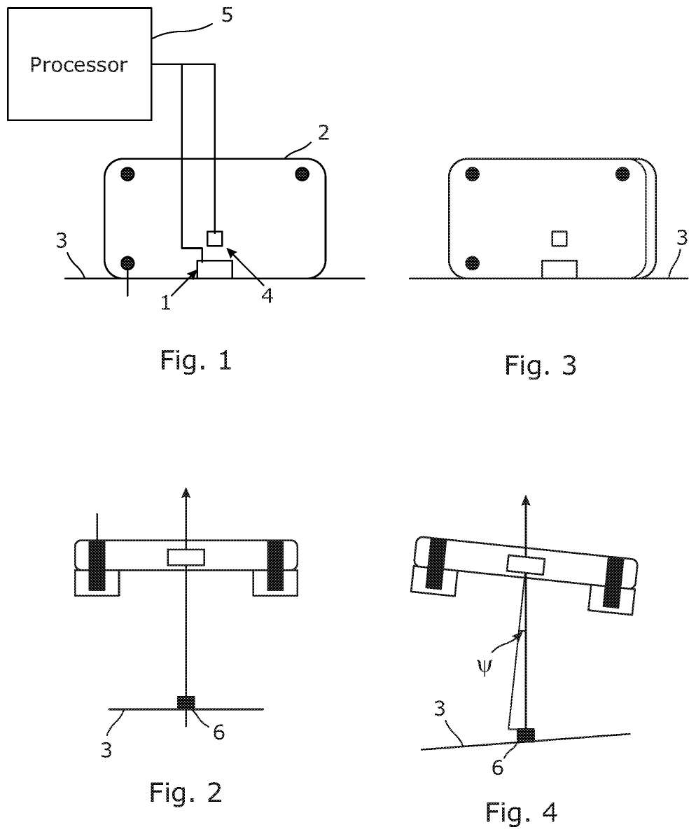

FIG. 1 is an elevation of a radar unit with a misalignment detection apparatus in accordance with an embodiment of the invention;

FIG. 2 is a plan view of the radar unit of FIG. 1; and

FIGS. 3 and 4 are corresponding views of the radar unit of FIG. 1 to which a misalignment has been applied.

The accompanying figures show an embodiment of the invention, which uses a rotational speed sensor 1 comprising a gyroscope to determine whether a radar unit 2 has been misaligned.

Typically, the radar unit 2 will be carefully aligned relative to the vehicle 3 on manufacturing of the vehicle 3, with its position being calibrated. It is desirable to know, typically within a few seconds of starting the vehicle, before it is driven away, whether that careful positioning has been disturbed (e.g. by an impact).

As such, the radar unit comprises the rotational speed sensor 1, which is arranged to measure the rotational speed of the radar unit 2 about a generally vertical axis. The output of the rotational speed sensor 1 is the results of this measurement, and is coupled to a processor 5.

The radar unit also comprises a three-axis accelerometer 4 which is also coupled to the processor 5. This measures the acceleration of the radar unit along three axes—typically two perpendicular horizontal axes and one vertical axis. The apparatus is further provided with a vehicle accelerometer 6 which is mounted on the vehicle 3 spaced apart from the radar unit 2 and measures the acceleration of the vehicle about three axes—again typically two perpendicular horizontal axes and one vertical axis. The output of the vehicle accelerometer 6 is also coupled to the processor 5.

Thus, by comparing the output of the two accelerometers 4, 6 at different times with the vehicle stationary, it is possible to determine whether there has been misalignment about any horizontal axis. In particular, pitch and roll information is typically available. However, it is not possible whilst the vehicle is stationary to detect with the accelerometers any misalignment that is purely about the vertical axis, as whilst the vehicle is stationary, the only force acting on the vehicle is gravity, and a rotation about a vertical axis will not change the direction in which gravity pulls the accelerometers.

As such, the rotational speed sensor 1 assists with detecting misalignment about a vertical axis. The rotational speed sensor is arranged to continually measure the rotational speed of the radar unit about the generally vertical axis. The processor 5 integrates this value to determine whether there has been any misalignment.

In general, when the vehicle 3 is stationary, the rotational speed sensor 1 output will be approximately zero although there may be some small offset due to drift, etc. However, when an event, such as a minor bump from another vehicle, occurs which causes yaw angular misalignment of the radar unit 2 (that is, rotation about a vertical axis), the rotational speed sensor 1 will detect this rotation. By integrating the yaw rate signal over the period during which the rotational misalignment occurs, the actual angle of yaw misalignment can be computed. This, together with pitch and roll angular misalignments derived from measurements of the components of gravitational acceleration experienced by the accelerometers 4, 6, gives the full tilt angle information required to allow correction of the radar signals (or, in the case of too great a degree of tilt, to enable the system automatically to go into a degraded or non-functioning mode of operation, with appropriate driver warning).

The rotational speed signal could, for example, be initially stored, and then the integration of the stored signal performed in software either immediately after the event, or at the next time the vehicle ignition is turned on.

For the system to operate as described above, the rotational speed sensor 1 must always be ready to measure the rotational speed in the case of a misalignment event occurring. This means that the device must always be on, or else capable of waking up from a sleep mode sufficiently quickly, to register accurately any changes in rotational speed occurring during the misalignment event, so that an accurate measurement of misalignment angle can be derived.

Many Microelectromechanical systems (MEMS) type accelerometers and rotational speed sensors have low power operating modes, drawing only small amounts of current, and it is anticipated that a rotational speed sensor continually operating in such a mode, even when the vehicle is parked, would be able to detect and register any misalignment event occurring without drawing an unacceptable amount of power during ignition off.

Assuming that yaw rate changes are registered and stored internally as described above, the actual roll, pitch and yaw tilt angles may be derived either immediately following the misalignment event, or alternatively at the next ignition on, before the vehicle drives off.

Detection of a misalignment event by the rotational speed sensor 1 is itself an indication that misalignment of the radar unit has occurred. If the rotational speed sensor 1 is capable of waking up sufficiently quickly to measure and store rotational speed data only during the actual misalignment event (or events in the case of more than one occurring during an ignition off period), then the only stored data will be that pertaining specifically to the misalignment event(s).

If, on the other hand, the rotational speed sensor 1 is continually measuring and storing data, then an actual misalignment event will be indicated by the rotational speed signal crossing some predetermined threshold level. In this case, any drift of the rotational speed signal occurring during the ignition off period can be continually corrected for by re-zeroing the signal based on measured rate of change of the rotational speed signal (it can be assumed that a misalignment occurring as a result of a minor crash, for example, will lead to a rapid rate of change of rotational speed, easily distinguishable from general slow drift).

The principle advantage of the proposed scheme is that it enables detection of any angular misalignment of the radar sensor whilst the vehicle is still stationary before driving off. Hence, appropriate corrections can be applied to the radar sensor signal processing (or, in the case of too great an angular misalignment, setting the radar into a degraded or non-functioning mode of operation with appropriate driver warning) before driving off.

1. Apparatus for detecting misalignment of a radar unit of a vehicle, the apparatus comprising:
a rotational speed sensor arranged to measure the rotational speed of the radar unit about at least one axis and having an output for a signal indicative of the rotational speed
a processor arranged coupled to the output of the rotational speed sensor;
in which the processor is arranged to determine the misalignment at least in part based on the rotational speed measured by the rotational speed sensor.

2. The apparatus of claim 1, in which the least one axis consists of one generally vertical axis.

3. The apparatus of claim 1, comprising an accelerometer arranged to determine the acceleration of the radar unit along at least two axes, and having an output for a signal indicative of the acceleration coupled to the processor, with the processor being arranged to use the acceleration to determine the misalignment.

4. The apparatus of claim 3, in which the two axes are perpendicular to each other and to the at least one axis of the rotational speed sensor.

5. The apparatus of claim 1, in which the processor is arranged to determine the misalignment based upon the output of the rotational speed sensor by integrating the rotational speed.

6. The apparatus of claim 1, in which the apparatus is arranged so as to take measurements of the rotational speed regularly or continually over a period of time.

7. The apparatus of claim 6, in which the period of time comprises at least the period when an ignition of the vehicle is switched off.

8. The apparatus of claim 1, in which the rotational speed sensor is arranged to only measure the rotational speed if it exceeds a threshold.

9. The apparatus of claim 1 in which the rotational speed sensor comprises a gyroscope.

10. A vehicle having a radar unit and the apparatus of claim 1 attached thereto, in which the rotational speed sensor is attached to or integrated in the radar unit.

11. The vehicle of claim 10, provided with a further accelerometer coupled to the vehicle and able to determine the acceleration of the vehicle about two or three axes, with an output of the further accelerometer being coupled to the processor and the processor arranged to determine the misalignment based upon the acceleration of the vehicle.

12. A method of detecting misalignment of a radar unit of a vehicle, the method comprising measuring the rotational speed of the radar unit about at least one axis and having an output for a signal indicative of the rotational speed and determining the misalignment at least in part based on the measured rotational speed.

13. The method of claim 12, comprising determining, typically using an accelerometer, the acceleration of the radar unit along at least two axes and using the acceleration to determine the misalignment.

14. The method of claim 13, in which the two axes are perpendicular to each other and to the at least one axis about which the rotational speed is measured.

15. The method of claim 12, in which in which the least one axis consists of one generally vertical axis.

16. The method of claim 12, in which the method comprises determining the misalignment by integrating the rotational speed.

17. The method of claim 12, comprising taking measurements of the rotational speed regularly or continually over a period of time.

18. The method of claim 17, in which the period of time comprises at least the period when an ignition of the vehicle is switched off.
